(19) United States
(12) Patent Application Publication
(10) Pub. No.: US 2025/0198872 A1
(43) Pub. Date: Jun. 19, 2025

(54) METHOD FOR MEASURING CENTER OF MASS OF OBJECT, CONTROL DEVICE OF ROBOT, AND COMPUTER-READABLE STORAGE MEDIUM

(71) Applicant: UBTECH ROBOTICS CORP LTD, Shenzhen (CN)

(72) Inventors: SHENGWEN XIE, Shenzhen (CN); Ligang Ge, Shenzhen (CN); Chunjiang Fu, Shenzhen (CN)

(21) Appl. No.: 18/964,346

(22) Filed: Nov. 30, 2024

(30) Foreign Application Priority Data
Dec. 14, 2023 (CN) 202311723173.1

(51) Int. Cl. G01M 1/12; B25J 9/16

(52) U.S. Cl. CPC G01M 1/12; B25J 9/1674; B25J 9/1682

(57) ABSTRACT

A method for measuring a center of mass of an object includes: controlling a multi-arm robot to carry an object through multiple robotic arms to perform pose changing movements of the object; obtaining actual end pose data and actual end force parameters of an end effector of each robotic arm after the pose changing movements; according to the actual end pose data and actual end force parameters, performing center of mass position calculation based on a torque balance relationship of the end effectors of the robotic arms on the object, to obtain a current candidate position of a center of mass of the object; and determining whether a distance between the current candidate position of the center of mass and a most recently calculated historical candidate position of the center of mass before the pose changing movements is less than a distance threshold.

### CROSS REFERENCE TO RELATED APPLICATIONS

This application claims priority to Chinese Patent Application No. CN 202311723173.1, filed Dec. 14, 2023, which is hereby incorporated by reference herein as if set forth in its entirety.

### TECHNICAL FIELD

The present disclosure generally relates to robots, and in particular relates to a method for measuring the center of mass of an object, control device of a robot and computer-readable storage medium.

### BACKGROUND

With the continuous advancement of science and technology, robotics has garnered widespread attention across various industries due to its significant research and application value. At present, robotic arms are often utilized to carry objects at their end-effectors to perform a variety of operational tasks, such as object transportation, object throwing, and parabolic motion tasks.

For robots, the accuracy of the object's center of mass is a critical factor that impacts the effectiveness, rationality, and precision of the execution trajectory of robotic tasks. Therefore, accurately measuring the center of mass of the object being manipulated has become a pressing issue that needs to be addressed in modern robotic task execution processes.

Therefore, there is a need to provide a method for measuring the center of mass of an object to overcome the above-mentioned problems.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic block diagram of a control device for a multi-arm robot according to one embodiment.

FIG. 2 is a schematic diagram illustrating an object grasped by a multi-arm robot.

FIG. 3 is an exemplary flowchart of a method for measuring the center of mass of an object according to one embodiment.

FIG. 4 is a schematic flowchart of the sub-steps included in step S230 of FIG. 3.

FIG. 5 is an exemplary flowchart of a method for measuring the center of mass of an object according to another embodiment.

FIG. 6 is a schematic flowchart of the sub-steps included in step S270 of FIG. 5.

FIG. 7 is an exemplary block diagram of the object centroid measurement device according to one embodiment.

FIG. 8 is an exemplary block diagram of the object centroid measurement device according to another embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

The applicant has conducted extensive research and discovered that some conventional solutions for measuring an object's center of mass involve a single robotic arm grasping the object to estimate its center of mass. However, in certain scenarios, the object's weight may exceed the maximum load capacity of a single robotic arm, or the object's size is so large that it is impractical to design a gripper of sufficient size for the arm to grasp the object effectively. As a result, such center-of-mass measurement solutions based on a single robotic arm lack versatility and are not suitable for objects of varying sizes and/or weights. Moreover, these solutions fail to achieve accurate measurements of the position of the center of mass for objects with differing sizes and/or weights.

To address these issues, the present disclosure proposes a method, control device, and readable storage medium for measuring the center of mass of objects with varying sizes and/or weights. The method enables effective estimation of the position of the center of mass of an object during coordinated movements involving multiple robotic arms. Furthermore, the method continuously improves the accuracy of the center-of-mass position estimation until the maximum precision limit is reached. This ensures that the final estimated center-of-mass position aligns as closely as possible with the object's actual center-of-mass position. Consequently, the method enhances the precision and accuracy of center-of-mass position identification and achieves accurate measurements of the position of the center of mass for objects with varying sizes and/or weights.

Below, detailed explanations of some embodiments of the present disclosure are provided with reference to the accompanying drawings. Where there is no conflict, the following embodiments and their features may be combined.

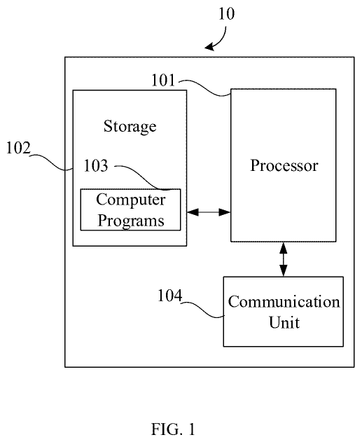

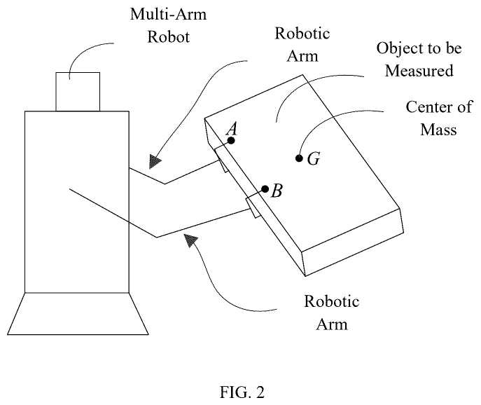

Referring to FIGS. 1 and 2, where FIG. 1 is a schematic block diagram illustrating the components of a control device 10 for a robot according to one embodiment, and FIG. 2 is a schematic diagram illustrating an object grasped by a multi-arm robot. In one embodiment, the control device 10 is electrically connected to and in communication with a multi-arm robot for controlling the multi-arm robot to move the object to be measured by the end effectors of multiple robotic arms in a coordinated manner, thereby obtaining the robotic arm motion parameters of the end effector of each robotic arm of the multi-arm robot during the movement of the object. Then, the actual center-of-mass position of the object to be measured can be estimated with high precision based on the obtained robotic arm motion parameters, so as to effectively improve the identification precision and accuracy of the center-of-mass position of the object.

The control device 10 can ensure that the control device 10 can accurately measure the center-of-mass position of objects to be measured of different sizes and/or weights by means of multiple robotic arms collaboratively grasping the object to be measured and moving it. The aforementioned robotic arm motion parameters may include the actual end position data and actual end force parameters of the end effectors of the corresponding robotic arms. The actual end position data may include the actual positions and actual poses of the robotic arm end coordinate systems of the corresponding robotic arms in the world coordinate system. The actual end force parameters include the actual force vectors and actual torque vectors of the corresponding robotic arms measured by force sensors for the object to be measured in the robotic arm end coordinate systems. The total number of the robotic arms included in the multi-arm robot may be at least two, and the end effectors of the multiple robotic arms included in the multi-arm robot each maintain fixed gripping positions on the object to be measured during the movement of the object to be measured. This ensures that the movement of each robotic arm's end-effector coordinate system effectively represents the movement of the contact point coordinate system at the corresponding gripping position.

Taking the object movement schematic diagram shown in FIG. 2 as an example, the multi-arm robot may be a dual-arm robot including two robotic arms. The end effectors of these two robotic arms simultaneously grip the object to be measured, with the gripping positions being contact point A and contact point B on the object. During the process of the multi-arm robot moving the object to be measured, the positions of contact points A and B remain unchanged.

It should be understood that, in the embodiments of the present disclosure, the control device 10 can be a computing device independent of the multi-arm robot, or a hardware module device integrated with the multi-arm robot. The computing device can include a personal computer, cloud server, laptop, tablet, or similar devices.

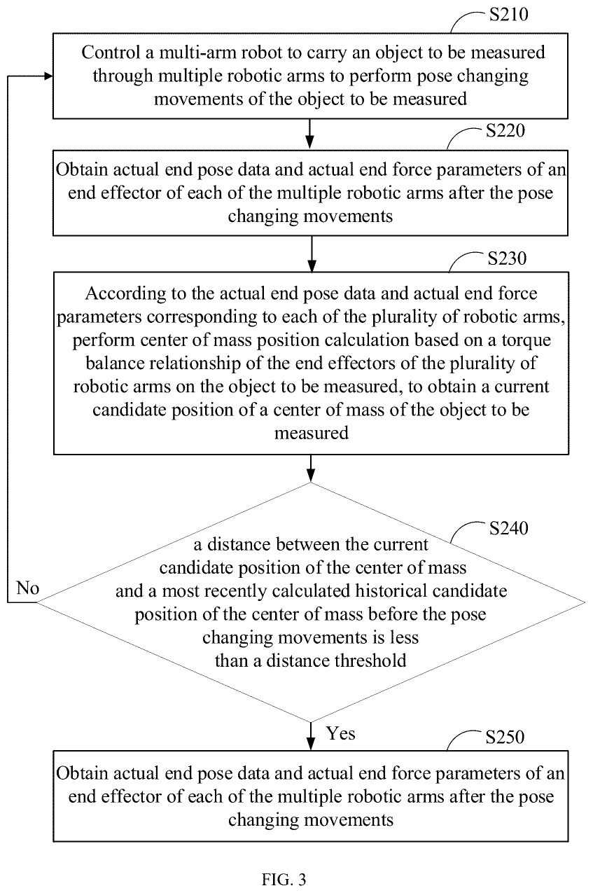

In one embodiment, the control device 10 may include a processor 101, a storage 102, one or more executable computer programs 103 that are stored in the storage 102, and a communication unit 104. The storage 102, the communication unit 104 and the processor 101 are directly or indirectly electrically connected to one another to realize data transmission or interaction. For example, they can be electrically connected to one another through one or more communication buses or signal lines. The processor 101 performs corresponding operations by executing the executable computer programs 103 stored in the storage 102. When the processor 101 executes the computer programs 103, the steps in the embodiments of a method for measuring the center of mass of an object, such as steps S210 to S250 in FIG. 3 are implemented.

The processor 101 may be an integrated circuit chip with signal processing capability. The processor 101 may be a central processing unit (CPU), a general-purpose processor, a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 101 can implement or execute the methods, steps, and logical blocks disclosed in the embodiments of the present disclosure.

The storage 102 may be, but not limited to, a random-access memory (RAM), a read only memory (ROM), a programmable read only memory (PROM), an erasable programmable read-only memory (EPROM), and an electrical erasable programmable read-only memory (EEPROM). The storage 102 may be an internal storage unit of the control device 10, such as a hard disk or a memory. The storage 102 may also be an external storage device of the control device 10, such as a plug-in hard disk, a smart memory card (SMC), and a secure digital (SD) card, or any suitable flash cards. Furthermore, the storage 102 may also include both an internal storage unit and an external storage device. The storage 102 is to store computer programs, other programs, and data required by the control device 10. The storage 102 can also be used to temporarily store data that have been output or is about to be output.

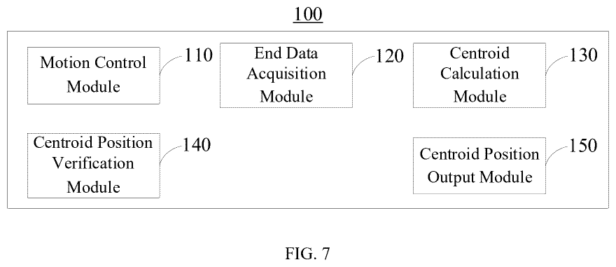

Exemplarily, the one or more computer programs 103 may be divided into one or more modules/units, and the one or more modules/units are stored in the storage 102 and executable by the processor 101. The one or more modules/units may be a series of computer program instruction segments capable of performing specific functions, and the instruction segments are used to describe the execution process of the one or more computer programs 103 in the control device 10. For example, the one or more computer programs 103 may be divided into a motion control module 110, an end data acquisition module 120, a centroid calculation module 130, a centroid position verification module 140 and a centroid position output module 150 as shown in FIG. 7.

In one embodiment, the communication unit 104 is to establish a communication connection between the control device 10 and other electronic devices through a network, and to send and receive data through the network. The network includes a wired communication network and/or a wireless communication network. For example, the control device 10 can obtain the object motion trajectory for the multi-arm robot from a motion trajectory planning device through the communication unit 104, so that the control device 10 can control the multi-arm robot to move the object to be measured using multiple robotic arms according to the object motion trajectory. As a result, the control device 10 can acquire the motion parameters of the multiple robotic arms when the object to be measured reaches a stable state, enabling high-precision estimation of the object's center of mass.

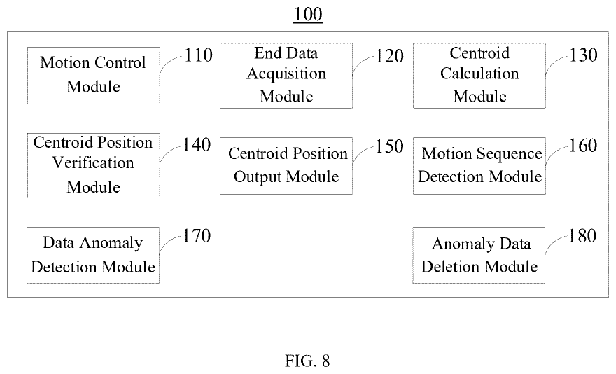

In one embodiment, an object centroid measurement device 100 (see FIGS. 7 and 8) may include at least one software function module that can be stored in the storage 102 in the form of software or firmware or embedded in the operating system of the control device 10. The processor 101 can execute the executable modules stored in the storage 102, such as the software function modules and computer programs included in the object centroid measurement device 100. The control device 10 can effectively estimate the center-of-mass position of an object through the object centroid measurement device 100 in the process of multiple robotic arms collaboratively moving the object to be measured. The control device 10 can continuously improve the accuracy of the center-of-mass position estimation until the maximum precision limit is reached. This ensures that the final estimated center-of-mass position aligns as closely as possible with the object's actual center-of-mass position. Consequently, the method enhances the precision and accuracy of center-of-mass position identification and achieves accurate measurements of the position of the center of mass for objects with varying sizes and/or weights. Furthermore, the object center-of-mass measurement solution proposed in the present disclosure ensures strong versatility, making it applicable to objects to be measured with varying sizes and/or weights, thereby achieving accurate center-of-mass measurement for objects of different sizes and/or weights.

It should be noted that the block diagram shown in FIG. 1 is only an example of the control device 10. The control device 10 may include more or fewer components than what is shown in FIG. 1, or have a different configuration than what is shown in FIG. 1. Each component shown in FIG. 1 may be implemented in hardware, software, or a combination thereof.

The present disclosure proposes a method for measuring the center of mass of an object. The method can ensure that the control device 10 can effectively estimate the center-of-mass position of an object to be measured during the coordinated movement process involving multiple robotic arms, and continuously improve the estimation accuracy until the maximum precision limit is reached—thereby making the final estimated center-of-mass position as consistent as possible with the actual center-of-mass position of the object to be measured—this enhances the precision and accuracy of center-of-mass identification. Additionally, it ensures that the object center-of-mass measurement solution proposed by the present disclosure is applicable to objects of varying sizes and/or weights. A detailed description of the proposed center-of-mass measurement method is provided below.

FIG. 3 is a flowchart of a method for measuring the center of mass of an object according to one embodiment. In one embodiment, the method may include steps S210 to S250.

Step S210: Control a multi-arm robot to carry an object to be measured through multiple robotic arms to perform pose changing movements of the object to be measured.

The pose change motion is to adjust the pose of the object to be measured, so that the pose of the object to be measured changes continuously under the carrying and moving action of the multi-arm robot. Each pose changing movement executed by the multi-arm robot can span one or more motion control cycles of the robot, ensuring that there is a significant difference in the object's pose before and after the corresponding pose changing movements.

The control device 10 controls the multi-arm robot to move the object to be measured to achieve the pose changing movements according to the pre-planned motion trajectory. In one embodiment, a robotic arm can be randomly selected from the multiple robotic arms included in the multi-arm robot as a reference robotic arm, and then motion trajectory planning can then be performed for this reference robotic arm. Subsequently, pose solving can be performed according to the robot kinematic relationship between each robotic arm except the reference robotic arm and the reference robotic arm. This results in an object motion trajectory composed of the respective motion trajectories of the end effectors of the multiple robotic arms.

Step S220: Obtain actual end pose data and actual end force parameters of an end effector of each of the multiple robotic arms after the pose changing movements.

After the control device 10 directs the multi-arm robot to complete the current pose changing movement while carrying the object to be measured, it retrieves the robotic arm motion parameters when the multi-arm robot effectively maintains the object to be measured in a stable state. This is achieved through the communication link between the control device 10 and the multi-arm robot. At this point, the robotic arm motion parameters can include the actual end pose data (also referred to actual end-effector pose data) and actual end force parameters (also referred to actual end-effector force parameters) of the end effectors of the multiple robotic arms gripping the object to be measured after the current pose changing movement. The actual end pose data includes the actual position and actual pose of the robotic arm end coordinate system of each robotic arm in the world coordinate system. The actual end force parameters include the actual force vector and actual torque vector of each robotic arm measured in the robotic arm end coordinate system for the object to be measured.

Step S230: According to the actual end pose data and actual end force parameters corresponding to each of the multiple robotic arms, perform center of mass position calculation based on a torque balance relationship of the end effectors of the multiple robotic arms on the object to be measured, to obtain a current candidate position of a center of mass of the object to be measured.

The torque balance relationship indicates that the arm end torques of the multiple robotic arms will cooperate with each other to maintain a balance with the object torque generated by the object gravity of the object to be measured in a stable state. Thus, after obtaining the actual end pose data and actual end force parameters of the end effectors of the multiple robotic arms after the current object pose changing movement, the center-of-mass position calculation can be performed for the object to be measured based on the torque balance relationship to estimate the current candidate position of the center of mass of the object to be measured after the current object pose changing movement.

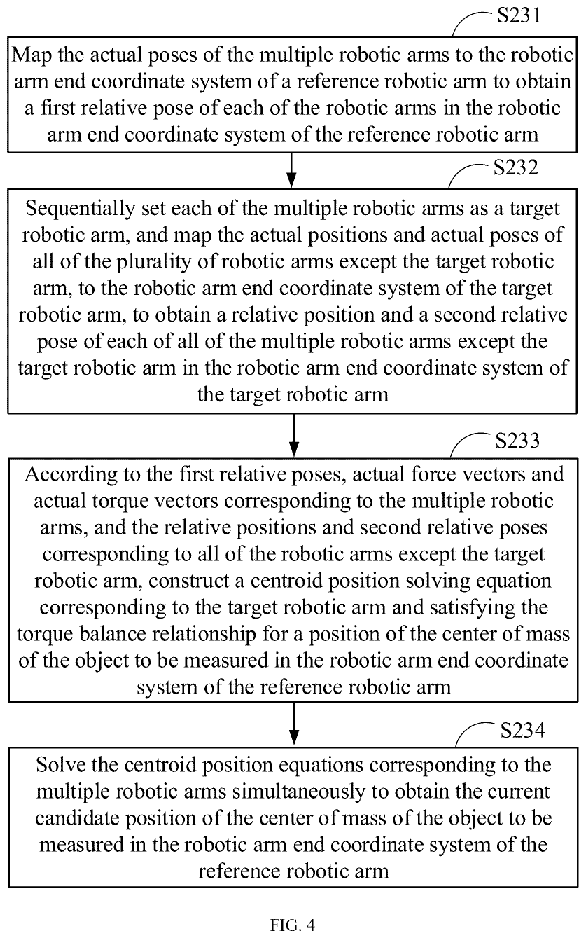

Referring to FIG. 4, in one embodiment, step S230 may include steps S231 to S234, which can effectively estimate the current candidate position of the center of mass of the object to be measured when the object achieves a stable state after the current pose changing movement.

Step S231: Map the actual poses of the multiple robotic arms to the robotic arm end coordinate system of a reference robotic arm to obtain a first relative pose of each of the robotic arms in the robotic arm end coordinate system of the reference robotic arm.

In one embodiment, the reference robotic arm is one of the multiple robotic arms. After being selected, the reference robotic arm will remain unchanged during the movement of the object (including multiple pose changing movements of the object). Take the multi-arm robot shown in FIG. 2 as an example, if the multi-arm robot includes a left robotic arm and a right robotic arm, the left robotic arm can be selected as the reference robotic arm of the multi-arm robot. The first relative pose corresponding to a single robotic arm is to represent the pose data of the robotic arm end coordinate system of the robotic arm in the robotic arm end coordinate system of the reference robotic arm. In one embodiment, the first relative pose corresponding to the reference robot arm can be represented by 1.

Step S232: Sequentially set each of the multiple robotic arms as a target robotic arm, and map the actual positions and actual poses of all of the multiple robotic arms except the target robotic arm, to the robotic arm end coordinate system of the target robotic arm, to obtain a relative position and a second relative pose of each of all of the multiple robotic arms except the target robotic arm in the robotic arm end coordinate system of the target robotic arm.

The relative position corresponding to a single robotic arm, other than the target robotic arm, represents the positional data of the robotic arm end coordinate system of that arm in the robotic arm end coordinate system of the target robotic arm. Similarly, the second relative pose corresponding to a single robotic arm, other than the target robotic arm, represents the pose data of the robotic arm end coordinate system of that arm in the robotic arm end coordinate system of the target robotic arm.

Step S233: According to the first relative poses, actual force vectors and actual torque vectors corresponding to the multiple robotic arms, and the relative positions and second relative poses corresponding to all of the robotic arms except the target robotic arm, construct a centroid position solving equation corresponding to the target robotic arm and satisfying the torque balance relationship for a position of the center of mass of the object to be measured in the robotic arm end coordinate system of the reference robotic arm.

In one embodiment, when a J-th robotic arm of the multiple robotic arms is set as the target robotic arm, the centroid position solving equation corresponding to the J-th robotic arm is expressed as follows:

$${\sum }_{i \neq J}^{m} ( {R}_{Ji} {M}_{i} + {P}_{Ji} \times {F}_{i} - {F}_{GJ} \times {R}_{Ni} {P}_{NG} ) = {M}_{J} ,$$

where m represents a total number of the multiple robotic arms, N represents the reference robotic arm of the multiple robotic arms, M_{J} represents the actual torque vector of the J-th robotic arm in the corresponding robotic arm end coordinate system thereof, R_{Ji} represents the second relative pose of an i-th robotic arm in the robotic arm end coordinate system of the J-th robotic arm, Mᵢ represents the actual torque vector of the i-th robotic arm in the corresponding robotic arm end coordinate system thereof, P_{Ji} represents the relative position of the i-th robotic arm in the robotic arm end coordinate system of the J-th robotic arm, Fᵢ represents the actual force vector of the i-th robotic arm in the corresponding robotic arm end coordinate system thereof, F_{GJ} represents a gravitational force vector of the object to be measured in the robotic arm end coordinate system of the J-th robotic arm, R_{Ni} represents the first relative pose of the i-th robotic arm in the robotic arm end coordinate system of the reference robotic arm, and P_{NG} represents the position of the center of mass of the object to be measured in the robotic arm end coordinate system of the reference robotic arm.

Taking the multi-arm robot shown in FIG. 2 as an example, if the multi-arm robot includes a left robotic arm and a right robotic arm, and the left robotic arm is selected as the reference robotic arm of the multi-arm robot, when the left robotic arm is selected as the target robotic arm, the equation for solving the center-of-mass position corresponding to the left robotic arm is expressed as follows:

$${R}_{LR} {M}_{R} + {P}_{LR} \times {F}_{R} - {F}_{GL} \times {R}_{LR} {P}_{LG} = {M}_{L} ,$$

where M_{L} represents the actual torque vector in the robotic arm end coordinate system of the left robotic arm, R_{LR} represents the second relative pose (or first relative pose) of the right robotic arm in the robotic arm end coordinate system of the left robotic arm, M_{R} represents the actual torque vector in the robotic arm end coordinate system of the right robotic arm, P_{LR} represents the relative position of the right robotic arm in the robotic arm end coordinate system of the left robotic arm, F_{R} represents the actual force vector in the robotic arm end coordinate system of the right robotic arm, F_{GL} represents the gravity vector of the object to be measured in the robotic arm end coordinate system of the left robotic arm, and P_{LG} represents the position of the center of mass of the object to be measured in the robotic arm end coordinate system of the left robotic arm.

When the right robotic arm is selected as the target robotic arm, the equation for solving the center-of-mass position corresponding to the right robotic arm is expressed as follows:

$${R}_{RL} {M}_{L} + {P}_{RL} \times {F}_{L} - {F}_{GR} \times {R}_{LL} {P}_{LG} = {R}_{RL} {M}_{L} + {P}_{RL} \times {F}_{L} - {F}_{GR} \times {P}_{LG} = {M}_{R} ,$$

where R_{RL} represents the second relative pose of the left robotic arm in the robotic arm end coordinate system of the right robotic arm, P_{RL} represents the relative position of the left robotic arm in the robotic arm end coordinate system of the right robotic arm, F_{L} represents the actual force vector in the robotic arm end coordinate system of the left robotic arm, F_{GR} represents the gravity vector of the object to be measured in the robotic arm end coordinate system of the right robotic arm, P_{LG} represents the position of the center of mass of the object to be measured in the robotic arm end coordinate system of the left robotic arm, and R_{LL} represents the first relative pose of the left robotic arm expressed as “1.”

Step S234: Solve the centroid position equations corresponding to the multiple robotic arms simultaneously to obtain the current candidate position of the center of mass of the object to be measured in the robotic arm end coordinate system of the reference robotic arm.

By executing the aforementioned steps S231 to S234, the current candidate position of the center of mass of the object to be measured is effectively estimated when it reaches a stable state after the current pose changing movement.

Step S240: Determine whether a distance between the current candidate position of the center of mass and a most recently calculated historical candidate position of the center of mass before the pose changing movements is less than a distance threshold.

In one embodiment, when the control device 10 controls the multi-arm robot to perform a pose changing movement and estimates the current candidate position of the center of mass corresponding to the object to be measured after the current pose changing movement, it will correspondingly retrieve the most recently calculated historical candidate position of the center of mass from storage 102 prior to the execution of the current pose changing movement and calculate the distance between the current candidate position of the center of mass and the historical candidate position of the center of mass. Then, by determining whether the distance is smaller than a preset distance threshold, it is determined whether the center-of-mass position corresponding to the current candidate position of the center of mass has reached the maximum precision limit. Both the current candidate position of the center of mass and the historical candidate position of the center of mass can be represented using position coordinates within the robotic arm end coordinate system of the reference robotic arm.

If the above-mentioned distance is not less than the preset distance threshold, it indicates that the center-of-mass position estimation accuracy corresponding to the current candidate position of the center of mass has not reached the maximum accuracy limit. If the above-mentioned distance is less than the preset distance threshold, it indicates that the center-of-mass position estimation accuracy corresponding to the current candidate position of the center of mass has reached the maximum accuracy limit. When the control device 10 controls the multi-arm robot to perform the pose changing movement for the first time, the origin of the robotic arm end coordinate system of the reference robotic arm can be used as the historical candidate position of the center of mass before the first pose changing movement to determine whether the center-of-mass position estimation accuracy after the first pose changing movement still has room for improvement.

In one embodiment, when the control device 10 detects that the above-mentioned distance between the current candidate position of the center of mass and the most recently calculated historical candidate position of the center of mass before the current pose changing movement is smaller than the preset distance threshold, it indicates that the center-of-mass position estimation accuracy after the current pose changing movement has essentially reached the maximum precision limit. This means that the estimated center-of-mass position after this movement is currently closest to the actual center-of-mass position of the object to be measured. At this point, the control device 10 will proceed to execute step S250. When the control device 10 detects that the above-mentioned distance between the current candidate position of the center of mass and the most recently calculated historical candidate position of the center of mass before the current pose changing movement is not less than the preset distance threshold, it indicates that there is still room for improvement in the center-of-mass position estimation accuracy the after the current pose changing movement. This means that the estimated center-of-mass position after this movement shows a significant difference from the actual center-of-mass position of the object to be measured. In this case, the control device 10 will return back to step S210 and continue executing steps S210 through S240 until the above-mentioned distance is less than the preset distance threshold. This process enables the effective estimation of the object's center-of-mass position during the coordinated movement of multiple robotic arms handling the object to be measured. It continuously improves the accuracy of the center-of-mass position estimation until the maximum precision limit is reached, ensuring that the final estimated center-of-mass position is as consistent as possible with the actual center-of-mass position of the object to be measured, thereby enhancing the precision and accuracy of center-of-mass position identification.

Step S250: In response to the distance being less than the distance threshold, determine the current candidate position of the center of mass as the actual position of the center of mass of the object to be measured.

In one embodiment, when the control device 10 detects that the distance between the current candidate position of the center of mass after the current pose changing movement and the most recently calculated historical candidate position of the center of mass before the current pose changing movement is less than the preset distance threshold, it indicates that the center-of-mass position estimation accuracy after the current pose changing movement has actually reached the maximum accuracy limit, and the estimated object's center-of-mass position after the current pose changing movement is currently closest to the actual center-of-mass position of the object to be measured. At this point, the control device 10 will directly use the current candidate position of the center of mass after the current pose changing movement as the actual center-of-mass position of the object to be measured, thereby effectively estimating the object's center-of-mass position in the process of multiple robotic arms collaboratively moving the object to be measured, while continuously improving the object's center-of-mass position estimation accuracy until the maximum accuracy limit is reached. This ensures that the final estimated object's center-of-mass position is as consistent as possible with the actual center-of-mass position of the object to be measured, thereby improving the precision and accuracy of center-of-mass position identification.

Thus, by executing the above steps S210 to S250, the control device 10 enables the effective estimation of the object's center-of-mass position during the coordinated movement of multiple robotic arms handling the object to be measured. It continuously improves the accuracy of the center-of-mass estimation until the maximum precision limit is reached, ensuring that the final estimated center-of-mass position aligns as closely as possible with the actual center-of-mass position of the object to be measured. This enhances the precision and accuracy of center-of-mass position identification. Additionally, by employing the method of multiple robotic arms working collaboratively to grip and move the object to be measured, this center-of-mass measurement solution is adaptable to objects of varying sizes and/or masses, enabling accurate center-of-mass position measurements for objects with different dimensions and/or weights.

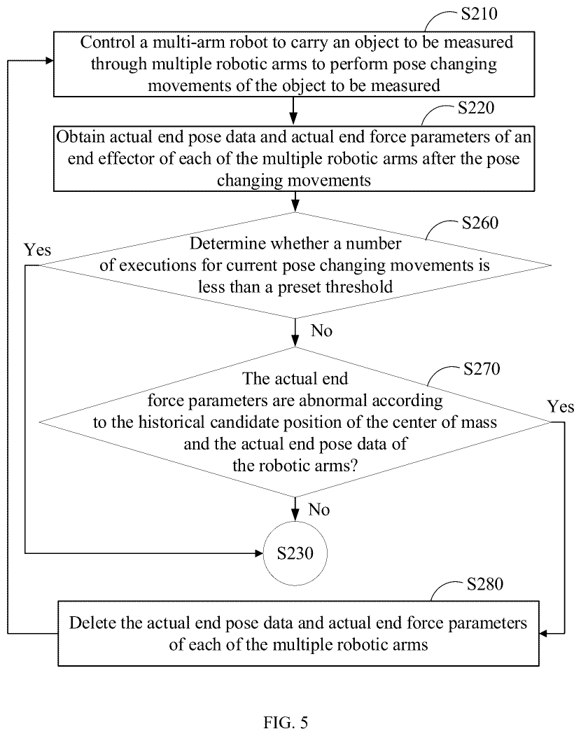

FIG. 5 illustrates a flowchart of a center-of-mass measurement method according to another embodiment. In this embodiment, compared to the method shown in FIG. 2, the center-of-mass measurement method in FIG. 5 additionally includes steps S260 to S280 between steps S220 and S230. These steps are designed to select an appropriate timing to exclude abnormal robotic arm motion parameters during the coordinated movement of the object to be measured by multiple robotic arms. This approach further enhances the accuracy of the center-of-mass position estimation, avoids interference from abnormal motion parameters on the final estimated center-of-mass position, and improves the precision of center-of-mass position identification.

Step S260: Determine whether a number of executions for current pose changing movements is less than a preset threshold.

In one embodiment, the number of executions represents the total number of executions of the pose changing movements at the multi-arm robot. After the multi-arm robot completes one pose changing movement, the control device 10 will add one to the current number of executions. Therefore, after obtaining the actual end pose data and actual end force parameters of each of the multiple robotic arms after the current pose changing movement, the control device 10 can compare the number of executions corresponding to the current pose changing movement with the preset threshold to determine whether the robotic arm motion parameters (i.e., actual end pose data and actual end force parameters) obtained from the current pose changing movement require anomaly verification processing. The preset threshold can be 4, 5, or 6, with the specific value configurable based on the required accuracy of the center-of-mass estimation.

If it is detected that the number of executions of the current pose changing movement is less than the preset threshold, this indicates that the robotic arm motion parameters (i.e., actual end pose data and actual end force parameters) obtained from the current pose changing movement are not yet at an appropriate stage for anomaly verification processing. At this point, the most recently obtained historical candidate position of the center of mass before this pose changing movement still shows a significant difference from the actual center-of-mass position of the object to be measured. In this case, the control device 10 will proceed to execute step S230 to estimate the object's center-of-mass position based on the robotic arm motion parameters obtained from the current pose changing movement.

If it is detected that the number of executions of the current pose changing movement is not less than the preset threshold, this indicates that the robotic arm motion parameters obtained from the current pose changing movement have reached an appropriate stage for anomaly verification processing. At this point, the most recently obtained historical candidate position of the center of mass before this pose changing movement is already relatively close to the actual center-of-mass position of the object to be measured. In this case, the control device 10 will execute step S270 to perform anomaly verification processing on the robotic arm motion parameters obtained from the current pose changing movement.

Step S270: Determine whether the actual end force parameters of the multiple robotic arms are abnormal according to the historical candidate position of the center of mass and the actual end pose data of the multiple robotic arms.

In one embodiment, when the control device 10 determines that the robotic arm motion parameters obtained from the current pose changing movement have reached an appropriate stage for anomaly verification processing, it will use the most recently calculated historical candidate position of the center of mass before the current pose changing movement. Combined with the actual end pose data of the multiple robotic arms obtained after the current pose changing movement, it will assess whether the actual end force parameters of each robotic arm obtained after the pose changing movement show anomalies. This determination is used to establish whether the robotic arm motion parameters from the current pose changing movement constitute anomalous data that could affect the accuracy of the center-of-mass position estimation.

When the control device 10 detects that the actual end force parameters of at least one of the robotic arms exhibit anomalies, it determines that the robotic arm motion parameters obtained from the current pose changing movement constitute anomalous data that could affect the accuracy of the center-of-mass position estimation. At this point, the control device 10 will execute step S280 to exclude the anomalous robotic arm motion parameters during the process of multiple robotic arms collaboratively moving the object to be measured. This approach further enhances the precision of the center-of-mass position estimation, prevents interference from anomalous data with the final estimated center-of-mass position, and improves the accuracy of center-of-mass position identification.

When the control device 10 detects that the actual end force parameters of each robotic arm do not exhibit any anomalies, it determines that the robotic arm motion parameters obtained from the current pose changing movement do not constitute anomalous data that could affect the accuracy of the center-of-mass position estimation. At this point, the control device 10 will proceed to execute step S230, enabling the estimation of the object's center-of-mass position based on the robotic arm motion parameters obtained from this pose changing movement.

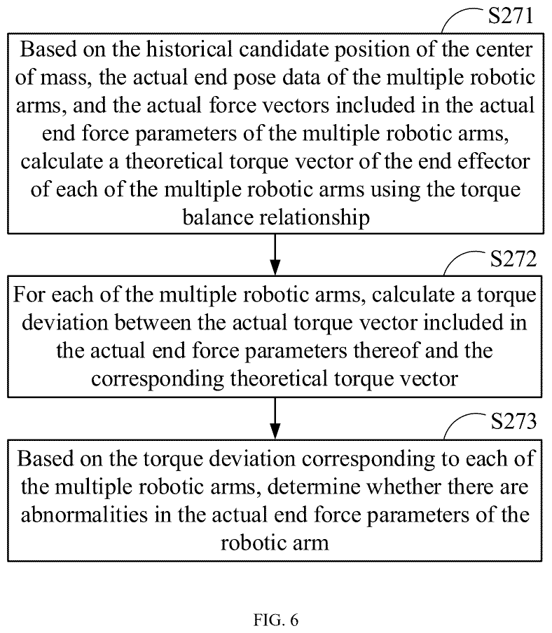

Referring to FIG. 6, in one embodiment, step S270 may include steps S271 to S273 to effectively verify whether the robotic arm motion parameters obtained from the current pose changing movement constitute anomalous data that could affect the accuracy of the center-of-mass position estimation.

Step S271: Based on the historical candidate position of the center of mass, the actual end pose data of the multiple robotic arms, and the actual force vectors included in the actual end force parameters of the multiple robotic arms, calculate a theoretical torque vector of the end effector of each of the multiple robotic arms using the torque balance relationship.

In one embodiment, the control device 10 can process the actual end pose data of each robotic arm with reference to steps S231 and S232 described above. Subsequently, the processed data, the historical candidate position of the center of mass, and the actual force vectors corresponding to each robotic arm are substituted into the center-of-mass position solving equations for each robotic arm described in step S234 above. This yields torque vector equation related to the theoretical torque vectors of the end-effectors of the robotic arms. By solving these torque vector equations simultaneously for each robotic arm, the theoretical torque vectors required for the end-effectors of the robotic arms after the current pose changing movement can be determined.

Step S272: For each of the multiple robotic arms, calculate a torque deviation between the actual torque vector included in the actual end force parameters thereof and the corresponding theoretical torque vector.

Step S273: Based on the torque deviation corresponding to each of the multiple robotic arms, determine whether there are abnormalities in the actual end force parameters of the robotic arm.

In one embodiment, the step of determine whether there are abnormalities in the actual end force parameters of the robotic arm based on the torque deviation corresponding to each of the multiple robotic arms can include the following steps: compare the torque deviation of each robotic arm with a preset deviation threshold corresponding to the robotic arm; and if the torque deviation is less than the preset deviation threshold, it is determined that the actual end force parameters of the robotic arm are not abnormal; otherwise, it is determined that the actual end force parameters of the robotic arm are abnormal.

Thus, by executing the above steps S271 to S273, the control device 10 can effectively verify whether the robotic arm motion parameters obtained from the current pose changing movement constitute abnormal data that impacts the accuracy of the center-of-mass position estimation.

Step S280: Delete the actual end pose data and actual end force parameters of each of the multiple robotic arms.

In one embodiment, when the control device 10 detects that the actual end force parameters of at least one robotic arm among the multiple robotic arms are abnormal, it determines that the robotic arm motion parameters obtained from the current pose changing movement constitute abnormal data affecting the accuracy of center-of-mass position estimation. At this point, the control device 10 deletes the robotic arm motion parameters (including the actual end pose data and actual end force parameters of each robotic arm) obtained from the current pose changing movement, and then returns back to step S210 to continue execution. This prevents the use of abnormal robotic arm motion parameters for estimating the object's center-of-mass position, improves the accuracy of the center-of-mass position estimation, and avoids interference from abnormal robotic arm motion parameters with the final estimated center-of-mass position, thereby enhancing the precision and accuracy of center-of-mass position identification.

Thus, this control device 10 can further improve the accuracy of the object's center-of-mass position estimation by performing steps S260 to S280 during the execution of steps S210 to S250, effectively selecting the appropriate time to exclude abnormal robotic arm motion parameters during the process of collaboratively moving the object to be measured with multiple robotic arms. This helps avoid interference from abnormal data in the final estimated center-of-mass position, thereby enhancing the accuracy of center-of-mass position identification.

It should be understood that sequence numbers of the foregoing processes do not mean an execution sequence in the above-mentioned embodiments. The execution sequence of the processes should be determined according to functions and internal logic of the processes, and should not be construed as any limitation on the implementation processes of the above-mentioned embodiments.

In one embodiment, to ensure that the control device 10 can effectively execute the above-mentioned method for measuring the center of mass of an object, the proposed functionality is achieved by dividing the object centroid measurement device 100 stored within the control device 10 into functional modules. Below, a detailed description of the specific components of the object centroid measurement device 100, as applied to the aforementioned control device 10, is provided.

FIG. 7 is an exemplary block diagram of the object centroid measurement device 100 according to one embodiment. In one embodiment, the object centroid measurement device 100 may include a motion control module 110, an end data acquisition module 120, a centroid calculation module 130, a centroid position verification module 140 and a centroid position output module 150.

The motion control module 110 is to control a multi-arm robot to carry an object to be measured through multiple robotic arms to perform pose changing movements of the object to be measured. The end data acquisition module 120 is to obtain actual end pose data and actual end force parameters of an end effector of each of the multiple robotic arms after the pose changing movements. The centroid calculation module 130 is to, according to the actual end pose data and actual end force parameters corresponding to each of the multiple robotic arms, perform center of mass position calculation based on a torque balance relationship of the end effectors of the multiple robotic arms on the object to be measured, to obtain a current candidate position of a center of mass of the object to be measured. The centroid position verification module 140 is to determine whether a distance between the current candidate position of the center of mass and a most recently calculated historical candidate position of the center of mass before the pose changing movements is less than a distance threshold. The centroid position output module 150 is to, in response to the distance being less than the distance threshold, determine the current candidate position of the center of mass as the actual position of the center of mass of the object to be measured; and in response to the distance being equal to or greater than the distance threshold, drive the motion control module 110 to continue controlling the multi-arm robot to carry the object to be measured with multiple robotic arms, performing pose changing movements.

FIG. 8 is an exemplary block diagram of the object centroid measurement device 100 according to another embodiment. In this embodiment, the object centroid measurement device 100 may further include a motion sequence detection module 160, a data anomaly detection module 170, and an anomaly data deletion module 180.

The motion sequence detection module 160 is to detect whether the number of executions corresponding to the current pose changing movement is less than a preset threshold, in the case where the end data acquisition module 120 has obtained the actual end pose data and actual end force parameters of each robotic arm's end effector after the pose changing movement.

The motion sequence detection module 160 is to, in response to the number of executions corresponding to the current pose changing movement being less than a preset threshold, drive the centroid calculation module 130 to, according to the actual end pose data and actual end force parameters corresponding to each of the multiple robotic arms, perform center of mass position calculation based on a torque balance relationship of the end effectors of the multiple robotic arms on the object to be measured, to obtain a current candidate position of a center of mass of the object to be measured.

The data anomaly detection module 170 is to, in response to the motion sequence detection module 160 detecting that the number of executions corresponding to the current pose changing movement is equal to or greater than the preset threshold, determine whether the actual end force parameters of the multiple robotic arms are abnormal according to the historical candidate position of the center of mass and the actual end pose data of the multiple robotic arms.

The anomaly data deletion module 180 is to, in response to the data anomaly detection module 170 detecting that the actual end force parameters of at least one of the multiple robotic arms are abnormal, delete the actual end pose data and actual end force parameters of each of the multiple robotic arms, and drive the motion control module 110 to control the multi-arm robot to carry the object to be measured through multiple robotic arms to perform pose changing movements.

The data anomaly detection module 170 is further to, in response to none of the actual end force parameters of the multiple robotic arms being abnormal, drive the centroid calculation module 130 to calculate the object's center-of-mass position based on the actual end pose data and actual end force parameters corresponding to each of the multiple robotic arms, using torque balance relationship of the end effectors of the multiple robotic arms on the object to be measured, to obtain the current candidate position of the center of mass of the object to be measured.

It should be noted that the basic principles and technical effects of the object centroid measurement device 100 are the same as those of the aforementioned object centroid measurement method. For brevity, portions not mentioned in the embodiments related to the object centroid measurement device 100 can refer to the descriptions of the object centroid measurement method provided above.

Each unit in the device discussed above may be a software program module, or may be implemented by different logic circuits integrated in a processor or independent physical components connected to a processor, or may be implemented by multiple distributed processors.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

In summary, in the object centroid measurement method, control device, and computer-readable storage medium described in the embodiments above, the proposed approach involves controlling a multi-arm robot to use multiple robotic arms to carry the object to be measured and perform pose changing movements. The actual end pose data and actual end force parameters of the end effector of each robotic arm after the pose changing movement are obtained. Based on the torque balance relationship of the end effectors of the multiple robotic arms on the object to be measured, center of mass position calculation is performed to obtain the current candidate position of the center of mass of the object to be measured. Subsequently, if the distance between the current candidate position of the center of mass and the most recently calculated historical candidate position of the center of mass before the pose changing movement is not less than a preset distance threshold, the procedure returns back to controlling a multi-arm robot to use multiple robotic arms to carry the object to be measured and perform pose changing movements until the distance is less than the preset threshold. This ensures effective estimation of the object's center-of-mass position during the collaborative movement of multiple robotic arms with the object to be measured and continuously improves the accuracy of center-of-mass position estimation up to the maximum precision limit. The final estimated center-of-mass position is as close as possible to the actual center-of-mass position of the object to be measured, thereby improving the accuracy and precision of center-of-mass position identification. Furthermore, this measurement solution ensures high versatility, making it applicable to objects of varying sizes and/or weights, enabling accurate center-of-mass position measurement for different objects effectively.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. in addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method for measuring a center of mass of an object, the method comprising:
a) controlling a multi-arm robot to carry an object to be measured through a plurality of robotic arms to perform pose changing movements of the object to be measured;
b) obtaining actual end pose data and actual end force parameters of an end effector of each of the plurality of robotic arms after the pose changing movements;
c) according to the actual end pose data and actual end force parameters corresponding to each of the plurality of robotic arms, performing center of mass position calculation based on a torque balance relationship of the end effectors of the plurality of robotic arms on the object to be measured, to obtain a current candidate position of a center of mass of the object to be measured;
d) determining whether a distance between the current candidate position of the center of mass and a most recently calculated historical candidate position of the center of mass before the pose changing movements is less than a distance threshold;
e) in response to the distance being less than the distance threshold, determining the current candidate position of the center of mass as the actual position of the center of mass of the object to be measured; and
f) in response to the distance being equal to or greater than the distance threshold, returning to step a).

2. The method of claim 1, wherein the actual end pose data corresponding to each of the plurality of robotic arms comprises an actual position and an actual pose of a robotic arm end coordinate system of the corresponding robotic arm in a world coordinate system, and the actual end force parameters corresponding to each of the plurality of robotic arms comprises an actual force vector and an actual torque vector of the corresponding robotic arm measured in the robotic arm end coordinate system; performing the center of mass position calculation based on the torque balance relationship of the end effectors of the plurality of robotic arms on the object to be measured, to obtain the current candidate position of a center of mass of the object to be measured, comprise:
mapping the actual poses of the plurality of robotic arms to the robotic arm end coordinate system of a reference robotic arm to obtain a first relative pose of each of the plurality of robotic arms in the robotic arm end coordinate system of the reference robotic arm, wherein the reference robotic arm is one of the plurality of robotic arms;
sequentially setting each of the plurality of robotic arms as a target robotic arm, and mapping the actual positions and actual poses of all of the plurality of robotic arms except the target robotic arm, to the robotic arm end coordinate system of the target robotic arm, to obtain a relative position and a second relative pose of each of all of the plurality of robotic arms except the target robotic arm in the robotic arm end coordinate system of the target robotic arm;
according to the first relative poses, actual force vectors and actual torque vectors corresponding to the plurality of robotic arms, and the relative positions and second relative poses corresponding to all of the robotic arms except the target robotic arm, constructing a centroid position solving equation corresponding to the target robotic arm and satisfying the torque balance relationship for a position of the center of mass of the object to be measured in the robotic arm end coordinate system of the reference robotic arm; and
solving the centroid position equations corresponding to the plurality of robotic arms simultaneously to obtain the current candidate position of the center of mass of the object to be measured in the robotic arm end coordinate system of the reference robotic arm.

3. The method of claim 2, wherein when a J-th robotic arm of the plurality of robotic arms is set as the target robotic arm, the centroid position solving equation corresponding to the J-th robotic arm is expressed as follows:
$${\sum }_{i \neq J}^{m} ( {R}_{Ji} {M}_{i} + {P}_{Ji} \times {F}_{i} - {F}_{GJ} \times {R}_{Ni} {P}_{NG} ) = {M}_{J} ,$$
where m represents a total number of the plurality of robotic arms, N represents the reference robotic arm of the plurality of robotic arms, M_{J} represents the actual torque vector of the J-th robotic arm in the corresponding robotic arm end coordinate system thereof, R_{Ji} represents the second relative pose of an i-th robotic arm in the robotic arm end coordinate system of the J-th robotic arm, Mᵢ represents the actual torque vector of the i-th robotic arm in the corresponding robotic arm end coordinate system thereof, P_{Ji} represents the relative position of the i-th robotic arm in the robotic arm end coordinate system of the J-th robotic arm, Fᵢ represents the actual force vector of the i-th robotic arm in the corresponding robotic arm end coordinate system thereof, F_{GJ} represents a gravitational force vector of the object to be measured in the robotic arm end coordinate system of the J-th robotic arm, R_{Ni} represents the first relative pose of the i-th robotic arm in the robotic arm end coordinate system of the reference robotic arm, and P_{NG} represents the position of the center of mass of the object to be measured in the robotic arm end coordinate system of the reference robotic arm.

4. The method of claim 1, further comprising, before performing center of mass position calculation based on a torque balance relationship of the end effectors of the plurality of robotic arms on the object to be measured, to obtain the current candidate position of the center of mass of the object to be measured,
determining whether a number of executions for a current pose changing movement is less than a preset threshold;
in response to the number of executions being less the preset threshold, executing step b);
in response to the number of executions being equal to or greater than the preset threshold, determining whether the actual end force parameters of the plurality of robotic arms are abnormal according to the historical candidate position of the center of mass and the actual end pose data of the plurality of robotic arms;
in response to the actual end force parameters of at least one of the plurality of robotic arms being abnormal, deleting the actual end pose data and actual end force parameters of each of the plurality of robotic arms, and returning to step a); and
in response to none of the actual end force parameters of the plurality of robotic arms being abnormal, executing step c).

5. The method of claim 4, wherein determining whether the actual end force parameters of the plurality of robotic arms are abnormal according to the historical candidate position of the center of mass and the actual end pose data of the plurality of robotic arms comprises:
based on the historical candidate position of the center of mass, the actual end pose data of the plurality of the robotic arms, and the actual force vectors included in the actual end force parameters of the plurality of the robotic arms, calculating a theoretical torque vector of the end effector of each of the plurality of robotic arms using the torque balance relationship;
for each of the plurality of the robotic arms, calculating a torque deviation between the actual torque vector included in the actual end force parameters thereof and the corresponding theoretical torque vector; and
based on the torque deviation corresponding to each of the plurality of robotic arms, determining whether there are abnormalities in the actual end force parameters of the robotic arm.

6. The method of claim 5, wherein based on the torque deviation corresponding to each of the plurality of robotic arms, determining whether there are abnormalities in the actual end force parameters of the robotic arm comprises:
comparing the torque deviation corresponding to the robotic arm with a preset deviation threshold corresponding to the robotic arm; and
in response to the torque deviation being less than the preset difference threshold, determining that there are no abnormalities in the actual end force parameters of the robotic arm; and
in response to the torque deviation being equal to or greater than the preset difference threshold, determining that there are abnormalities in the actual end force parameter of the robotic arm.

7. A control device for a multi-arm robot, the control device comprising:
one or more processors; and
a memory coupled to the one or more processors, the memory storing programs that, when executed by the one or more processors, cause performance of operations comprising:
a) controlling a multi-arm robot to carry an object to be measured through a plurality of robotic arms to perform pose changing movements of the object to be measured;
b) obtaining actual end pose data and actual end force parameters of an end effector of each of the plurality of robotic arms after the pose changing movements;
c) according to the actual end pose data and actual end force parameters corresponding to each of the plurality of robotic arms, performing center of mass position calculation based on a torque balance relationship of the end effectors of the plurality of robotic arms on the object to be measured, to obtain a current candidate position of a center of mass of the object to be measured;
d) determining whether a distance between the current candidate position of the center of mass and a most recently calculated historical candidate position of the center of mass before the pose changing movements is less than a distance threshold;
e) in response to the distance being less than the distance threshold, determining the current candidate position of the center of mass as the actual position of the center of mass of the object to be measured; and
f) in response to the distance being equal to or greater than the distance threshold, returning to step a).

8. The control device of claim 7, wherein the actual end pose data corresponding to each of the plurality of robotic arms comprises an actual position and an actual pose of a robotic arm end coordinate system of the corresponding robotic arm in a world coordinate system, and the actual end force parameters corresponding to each of the plurality of robotic arms comprises an actual force vector and an actual torque vector of the corresponding robotic arm measured in the robotic arm end coordinate system; performing the center of mass position calculation based on the torque balance relationship of the end effectors of the plurality of robotic arms on the object to be measured, to obtain the current candidate position of a center of mass of the object to be measured, comprise:
mapping the actual poses of the plurality of robotic arms to the robotic arm end coordinate system of a reference robotic arm to obtain a first relative pose of each of the plurality of robotic arms in the robotic arm end coordinate system of the reference robotic arm, wherein the reference robotic arm is one of the plurality of robotic arms;
sequentially setting each of the plurality of robotic arms as a target robotic arm, and mapping the actual positions and actual poses of all of the plurality of robotic arms except the target robotic arm, to the robotic arm end coordinate system of the target robotic arm, to obtain a relative position and a second relative pose of each of all of the plurality of robotic arms except the target robotic arm in the robotic arm end coordinate system of the target robotic arm;
according to the first relative poses, actual force vectors and actual torque vectors corresponding to the plurality of robotic arms, and the relative positions and second relative poses corresponding to all of the robotic arms except the target robotic arm, constructing a centroid position solving equation corresponding to the target robotic arm and satisfying the torque balance relationship for a position of the center of mass of the object to be measured in the robotic arm end coordinate system of the reference robotic arm; and
solving the centroid position equations corresponding to the plurality of robotic arms simultaneously to obtain the current candidate position of the center of mass of the object to be measured in the robotic arm end coordinate system of the reference robotic arm.

9. The control device of claim 8, wherein when a J-th robotic arm of the plurality of robotic arms is set as the target robotic arm, the centroid position solving equation corresponding to the J-th robotic arm is expressed as follows:
$${\sum }_{i \neq J}^{m} ( {R}_{Ji} {M}_{i} + {P}_{Ji} \times {F}_{i} - {F}_{GJ} \times {R}_{Ni} {P}_{NG} ) = {M}_{J} ,$$
where m represents a total number of the plurality of robotic arms, N represents the reference robotic arm of the plurality of robotic arms, M_{J} represents the actual torque vector of the J-th robotic arm in the corresponding robotic arm end coordinate system thereof, R_{Ji} represents the second relative pose of an i-th robotic arm in the robotic arm end coordinate system of the J-th robotic arm, Mᵢ represents the actual torque vector of the i-th robotic arm in the corresponding robotic arm end coordinate system thereof, P_{Ji} represents the relative position of the i-th robotic arm in the robotic arm end coordinate system of the J-th robotic arm, Fᵢ represents the actual force vector of the i-th robotic arm in the corresponding robotic arm end coordinate system thereof, F_{GJ} represents a gravitational force vector of the object to be measured in the robotic arm end coordinate system of the J-th robotic arm, R_{Ni} represents the first relative pose of the i-th robotic arm in the robotic arm end coordinate system of the reference robotic arm, and P_{NG} represents the position of the center of mass of the object to be measured in the robotic arm end coordinate system of the reference robotic arm.

10. The control device of claim 7, wherein the operations further comprise, before performing center of mass position calculation based on a torque balance relationship of the end effectors of the plurality of robotic arms on the object to be measured, to obtain the current candidate position of the center of mass of the object to be measured,
determining whether a number of executions for a current pose changing movement is less than a preset threshold;
in response to the number of executions being less the preset threshold, executing step b);
in response to the number of executions being equal to or greater than the preset threshold, determining whether the actual end force parameters of the plurality of robotic arms are abnormal according to the historical candidate position of the center of mass and the actual end pose data of the plurality of robotic arms;
in response to the actual end force parameters of at least one of the plurality of robotic arms being abnormal, deleting the actual end pose data and actual end force parameters of each of the plurality of robotic arms, and returning to step a); and
in response to none of the actual end force parameters of the plurality of robotic arms being abnormal, executing step c).

11. The control device of claim 10, wherein determining whether the actual end force parameters of the plurality of robotic arms are abnormal according to the historical candidate position of the center of mass and the actual end pose data of the plurality of robotic arms comprises:
based on the historical candidate position of the center of mass, the actual end pose data of the plurality of the robotic arms, and the actual force vectors included in the actual end force parameters of the plurality of the robotic arms, calculating a theoretical torque vector of the end effector of each of the plurality of robotic arms using the torque balance relationship;
for each of the plurality of the robotic arms, calculating a torque deviation between the actual torque vector included in the actual end force parameters thereof and the corresponding theoretical torque vector; and
based on the torque deviation corresponding to each of the plurality of robotic arms, determining whether there are abnormalities in the actual end force parameters of the robotic arm.

12. The control device of claim 11, wherein based on the torque deviation corresponding to each of the plurality of robotic arms, determining whether there are abnormalities in the actual end force parameters of the robotic arm comprises:
comparing the torque deviation corresponding to the robotic arm with a preset deviation threshold corresponding to the robotic arm; and
in response to the torque deviation being less than the preset difference threshold, determining that there are no abnormalities in the actual end force parameters of the robotic arm; and
in response to the torque deviation being equal to or greater than the preset difference threshold, determining that there are abnormalities in the actual end force parameter of the robotic arm.

13. A non-transitory computer-readable storage medium storing instructions that, when executed by at least one processor of a control device, cause the at least one processor to perform a method, the method comprising:
a) controlling a multi-arm robot to carry an object to be measured through a plurality of robotic arms to perform pose changing movements of the object to be measured;
b) obtaining actual end pose data and actual end force parameters of an end effector of each of the plurality of robotic arms after the pose changing movements;
c) according to the actual end pose data and actual end force parameters corresponding to each of the plurality of robotic arms, performing center of mass position calculation based on a torque balance relationship of the end effectors of the plurality of robotic arms on the object to be measured, to obtain a current candidate position of a center of mass of the object to be measured;
d) determining whether a distance between the current candidate position of the center of mass and a most recently calculated historical candidate position of the center of mass before the pose changing movements is less than a distance threshold;
e) in response to the distance being less than the distance threshold, determining the current candidate position of the center of mass as the actual position of the center of mass of the object to be measured; and
f) in response to the distance being equal to or greater than the distance threshold, returning to step a).

14. The non-transitory computer-readable storage medium of claim 13, wherein the actual end pose data corresponding to each of the plurality of robotic arms comprises an actual position and an actual pose of a robotic arm end coordinate system of the corresponding robotic arm in a world coordinate system, and the actual end force parameters corresponding to each of the plurality of robotic arms comprises an actual force vector and an actual torque vector of the corresponding robotic arm measured in the robotic arm end coordinate system; performing the center of mass position calculation based on the torque balance relationship of the end effectors of the plurality of robotic arms on the object to be measured, to obtain the current candidate position of a center of mass of the object to be measured, comprise:
mapping the actual poses of the plurality of robotic arms to the robotic arm end coordinate system of a reference robotic arm to obtain a first relative pose of each of the plurality of robotic arms in the robotic arm end coordinate system of the reference robotic arm, wherein the reference robotic arm is one of the plurality of robotic arms;
sequentially setting each of the plurality of robotic arms as a target robotic arm, and mapping the actual positions and actual poses of all of the plurality of robotic arms except the target robotic arm, to the robotic arm end coordinate system of the target robotic arm, to obtain a relative position and a second relative pose of each of all of the plurality of robotic arms except the target robotic arm in the robotic arm end coordinate system of the target robotic arm;
according to the first relative poses, actual force vectors and actual torque vectors corresponding to the plurality of robotic arms, and the relative positions and second relative poses corresponding to all of the robotic arms except the target robotic arm, constructing a centroid position solving equation corresponding to the target robotic arm and satisfying the torque balance relationship for a position of the center of mass of the object to be measured in the robotic arm end coordinate system of the reference robotic arm; and
solving the centroid position equations corresponding to the plurality of robotic arms simultaneously to obtain the current candidate position of the center of mass of the object to be measured in the robotic arm end coordinate system of the reference robotic arm.

15. The non-transitory computer-readable storage medium of claim 14, wherein when a J-th robotic arm of the plurality of robotic arms is set as the target robotic arm, the centroid position solving equation corresponding to the J-th robotic arm is expressed as follows:
$${\sum }_{i \neq J}^{m} ( {R}_{Ji} {M}_{i} + {P}_{Ji} \times {F}_{i} - {F}_{GJ} \times {R}_{Ni} {P}_{NG} ) = {M}_{J} ,$$
where m represents a total number of the plurality of robotic arms, N represents the reference robotic arm of the plurality of robotic arms, M_{J} represents the actual torque vector of the J-th robotic arm in the corresponding robotic arm end coordinate system thereof, R_{Ji} represents the second relative pose of an i-th robotic arm in the robotic arm end coordinate system of the J-th robotic arm, Mᵢ represents the actual torque vector of the i-th robotic arm in the corresponding robotic arm end coordinate system thereof, P_{Ji} represents the relative position of the i-th robotic arm in the robotic arm end coordinate system of the J-th robotic arm, Fᵢ represents the actual force vector of the i-th robotic arm in the corresponding robotic arm end coordinate system thereof, F_{GJ} represents a gravitational force vector of the object to be measured in the robotic arm end coordinate system of the J-th robotic arm, R_{Ni} represents the first relative pose of the i-th robotic arm in the robotic arm end coordinate system of the reference robotic arm, and P_{NG} represents the position of the center of mass of the object to be measured in the robotic arm end coordinate system of the reference robotic arm.

16. The non-transitory computer-readable storage medium of claim 13, further comprising, before performing center of mass position calculation based on a torque balance relationship of the end effectors of the plurality of robotic arms on the object to be measured, to obtain the current candidate position of the center of mass of the object to be measured,
determining whether a number of executions for a current pose changing movement is less than a preset threshold;
in response to the number of executions being less the preset threshold, executing step b);
in response to the number of executions being equal to or greater than the preset threshold, determining whether the actual end force parameters of the plurality of robotic arms are abnormal according to the historical candidate position of the center of mass and the actual end pose data of the plurality of robotic arms;
in response to the actual end force parameters of at least one of the plurality of robotic arms being abnormal, deleting the actual end pose data and actual end force parameters of each of the plurality of robotic arms, and returning to step a); and
in response to none of the actual end force parameters of the plurality of robotic arms being abnormal, executing step c).

17. The non-transitory computer-readable storage medium of claim 16, wherein determining whether the actual end force parameters of the plurality of robotic arms are abnormal according to the historical candidate position of the center of mass and the actual end pose data of the plurality of robotic arms comprises:
based on the historical candidate position of the center of mass, the actual end pose data of the plurality of the robotic arms, and the actual force vectors included in the actual end force parameters of the plurality of the robotic arms, calculating a theoretical torque vector of the end effector of each of the plurality of robotic arms using the torque balance relationship;
for each of the plurality of the robotic arms, calculating a torque deviation between the actual torque vector included in the actual end force parameters thereof and the corresponding theoretical torque vector; and
based on the torque deviation corresponding to each of the plurality of robotic arms, determining whether there are abnormalities in the actual end force parameters of the robotic arm.

18. The non-transitory computer-readable storage medium of claim 17, wherein based on the torque deviation corresponding to each of the plurality of robotic arms, determining whether there are abnormalities in the actual end force parameters of the robotic arm comprises:
comparing the torque deviation corresponding to the robotic arm with a preset deviation threshold corresponding to the robotic arm; and
in response to the torque deviation being less than the preset difference threshold, determining that there are no abnormalities in the actual end force parameters of the robotic arm; and
in response to the torque deviation being equal to or greater than the preset difference threshold, determining that there are abnormalities in the actual end force parameter of the robotic arm.
